(19) United States
(12) Patent Application Publication
(10) Pub. No.: US 2026/0015275 A1
(43) Pub. Date: Jan. 15, 2026

(54) THERMAL DRIVEN WATER DESALINATION SYSTEM USING FORWARD OSMOSIS

(71) Applicant: Bob Cantrell, Salem, OR (US)

(72) Inventor: Bob Cantrell, Salem, OR (US)

(21) Appl. No.: 19/332,940

(22) Filed: Sep. 18, 2025

Related U.S. Application Data
(63) Continuation-in-part of application No. 18/816,355, filed on Aug. 27, 2024, now Pat. No. 12,448,304.
(60) Provisional application No. 63/534,863, filed on Aug. 28, 2023.
(60) Provisional application No. 63/622,793, filed on Jan. 19, 2024.

(51) Int. Cl. C02F 9/00; B01D 61/00; B01D 61/02; B01D 61/36; B01D 61/58; B01D 69/02; C02F 1/44; C02F 103/08

(52) U.S. Cl. CPC C02F 9/00; B01D 61/58; B01D 69/02; B01D 61/005; B01D 61/025; B01D 61/364; B01D 2313/221; B01D 2313/243; B01D 2325/38; C02F 1/441; C02F 1/445; C02F 1/447; C02F 2103/08; C02F 2301/063; C02F 2303/10

(57) ABSTRACT

A system and method for water desalination using. The system uses ammonium bicarbonate as the draw solution to draw out freshwater through a forward osmosis (FO) membrane from an amount of saltwater or other contaminated water initially directed through one side of the FO membrane. The ammonium bicarbonate draws the desalinated water through the membrane of the FO membrane. Brine or other solutes are directed away. The combination of desalinated water and ammonium bicarbonate is directed through a hydrophobic membrane housing to recoup additional freshwater and remove a large amount of the ammonium bicarbonate. The remaining water is directed to a reverse osmosis membrane housing to remove any residual remaining ammonium bicarbonate. The fresh water can then be directed out for treatment and end use.

### CROSS-REFERENCE TO RELATED APPLICATIONS

This application is a continuation in part application, which claims prior to non-provisional application Ser. No. 18/816,355 which was filed on Aug. 27, 2024, which claims priority to U.S. Provisional Patent Application No. 63/534,863 filed on Aug. 28, 2023, and U.S. Provisional Patent Application No. 63/622,793, which was filed on Jan. 19, 2024, which are incorporated by reference in their entirety.

### FIELD OF THE DISCLOSURE

The present invention relates to a system and method for water desalination that uses forward osmosis, a hydrophobic membrane, and reverse osmosis with a lower energy cost, little pre-treatment, and a powerful osmotic pressure draw through the use of an ammonium bicarbonate solution which is recovered for reuse by low-cost membrane distillation as well as the use of a heat pump for thermal regulation of temperatures.

### BACKGROUND

It is well known that the world has a freshwater scarcity problem. The problem of freshwater scarcity has been exacerbated due to climate change, drought, population growth, and increased industrial demand. It is estimated that globally about 26% of the population do not have safe drinking water and 46% of people lack access to safely managed sanitation.

97% of the water on Earth is contained in the oceans and/or deep saline water aquifers, and is thus undrinkable, because of the high concentration of salt content in the seawater. One option has been to look into pursuing desalination of saltwater to help unlock access to this plentiful supply of potential freshwater. Saltwater is readily available and easy to access. It may be desirable to desalinate saltwater in oceans that surround bodies of land that that have lower amounts of readily available freshwater, such as in the Middle East and Africa in order to provide a greater amount of freshwater. Unfortunately, the high cost and expense associated with desalination of saltwater has always been a problem for the major methods used today.

A well-known method of desalination of saltwater has been the use of reverse osmosis. Reverse osmosis involves forcing water through a membrane using hydraulic pressure. Forward osmosis is another method of water desalination and involves the use of natural osmotic pressure (very little hydraulic pressure usually) to induce the flow of water through the membrane. Forward osmosis (FO) is an osmotic process that, like reverse osmosis (RO), uses a semi-permeable membrane to effect separation of water from dissolved solutes.

Many issues persist with the use of reverse osmosis. The high pressures required to overcome saltwater's osmotic pressures is expensive and has been a challenge for reverse osmosis. Other methods, which include all distillation methods require high cost of heat to overcome the high cost of achieving latent heat requirements. Electrodialysis requires high electric costs to pull apart the sodium and chloride ions. Forward osmosis shows promise but to date the cost of recovering the draw solution has been too high except for special situations.

Accordingly, there is still need for a system using forward osmosis that uses a low cost of draw solution recovery that overcomes past failures.

### SUMMARY

The present description is directed to creating a partial vacuum in the water desalination system. The present description further comprises after creating the partial vacuum in the water desalination system, raising the temperature of incoming salt water prior to directing the incoming salt water to a forward osmosis (FO) membrane housing. After step, the heated incoming salt water is directed to an inlet of a feed side of the (FO) membrane housing. After this step, a first amount of concentrated ammonium bicarbonate solution is directed into a draw side of the FO membrane housing, whereby the feed side and the draw side of the FO membrane housing are separated by a FO permeable membrane. The concentrated ammonium bicarbonate solution functions as a draw solution in the FO membrane housing. In a next step, as a result of osmotic pressure, a minimum period of time is allowed to pass for the concentrated ammonium bicarbonate to pull a percentage of desalinated product water from the feed side through the FO permeable membrane to the draw side of the FO membrane housing. The next step comprises flowing brine or other extracted contaminant solutes pulled through the FO membrane housing in the feed side of the FO membrane housing to a collection point for the brine or the other extracted contaminant solutes. The next step comprises flowing a resulting solution from the draw side of the FO membrane housing, wherein the resulting solution is a combination of the percentage of desalinated product water and ammonium bicarbonate solution and wherein the resulting solution is a diluted ammonium bicarbonate solution. The next step comprises pumping the resulting solution to a vacuum tank and directing the pumped resulting solution to a heat source to raise the temperature of the resulting solution. After this step, the resulting solution comprising the diluted ammonium bicarbonate is allowed to flow from the heat source into a feed side of a hydrophobic membrane housing, wherein the hydrophobic membrane housing comprises a hydrophobic membrane that permits gases to flow through the hydrophobic membrane from the feed side of the hydrophobic membrane housing to a draw side of the hydrophobic membrane housing, wherein the gases are ammonia, carbon dioxide, and water vapor. After this step, the heated resulting solution is allowed to be filtered through a hydrophobic membrane of the hydrophobic membrane housing, wherein any ammonium bicarbonate ions in the heated resulting solution are converted or dissociate into the gases in the feed side of the hydrophobic membrane housing, wherein the gases pass through the through the hydrophobic membrane from the feed side of the hydrophobic membrane housing to the draw side of the hydrophobic membrane housing, leaving behind freshwater product water to flow out of the feed side of the hydrophobic membrane housing with traceable amounts of ammonium bicarbonate ions present in the freshwater product water. After this step, the freshwater product water flows from the feed side of the hydrophobic membrane housing into a feed side of a reverse osmosis (RO) membrane housing. Along with this step, additional clean water is directed into a draw side of the RO membrane housing. After this step, an amount of water in the freshwater product water is allowed to be drawn through a membrane of the RO membrane housing, while the traceable amounts of the ammonium bicarbonate ions remain on the feed side of the RO membrane housing. After this step, the resulting freshwater product water having no amount of ammonium bicarbonate ions out of the draw side of the RO membrane housing flows towards a vacuum tank to be pumped in and out of the vacuum tank. After this step, the method includes flowing the pumped resulting freshwater product water into a first heat exchanger to raise the temperature of the pumped resulting freshwater product water. After this step, the pumped resulting freshwater product water flows from the first heat exchanger for further treatment and end use.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows a block diagram of exemplary components of a water desalination system that utilizes forward osmosis, reverse osmosis, and an ammonium bicarbonate solution as a draw solution as well as a water heat pump and a hydrophobic membrane housing to generate freshwater and to recycle and reuse the draw solution.

FIG. 2 shows a pictorial illustration flowchart with an exemplary method of use of the water desalination system shown in FIG. 1 that utilizes a forward osmosis membrane housing, a hydrophobic membrane, and a reverse osmosis membrane housing as well as solutions containing various amounts of ammonium bicarbonate and/or salt for desalination or other contaminants that need extraction to product clean useable water.

### DETAILED DESCRIPTION

The present description relates to a useful method and system for water desalination using forward osmosis that has the potential to achieve high rates of freshwater recovery from various sources of not fresh water, such as but not limited to, saltwater obtained from oceans and deep-sea aquifers, or polluted and/or contaminated water sources, such as mining, fracking, and industrial wastewater. The forward osmosis process uses a forward osmosis membrane that separates out a great percentage of salt from incoming salt water or separates out other contaminants from contaminated water. The system further utilizes a hydrophobic membrane to remove the ammonium bicarbonate from the diluted ammonium bicarbonate solution directed to the hydrophobic membrane.

The formula for ammonium bicarbonate is notably: (NH4)(i)+HCO3(i) in H2O⇄CO2(g)+NH3(g)+H2O

The system further utilizes a reverse osmosis membrane to remove residual ammonium bicarbonate to ensure that the fresh water produced by the system or the permeate product water has minimal traces of ammonium bicarbonate. The forward osmosis membrane operates using osmotic pressure draw. The hydrophobic membrane utilizes a temperature differential in order to separate the first amount of ammonium bicarbonate from the diluted ammonium bicarbonate directed through the hydrophobic membrane. The innovative use of hydrophobic differential temperature membrane as described herein is utilized as a pathway to a low-cost draw recovery method.

The reverse osmosis membrane works on the basis of low pressure to help ensure that more ammonium bicarbonate is pulled out of or removed from the fresh water ejected from the hydrophobic membrane. The removed residual ammonium bicarbonate may also be recycled to be used in a subsequent desalination run or process.

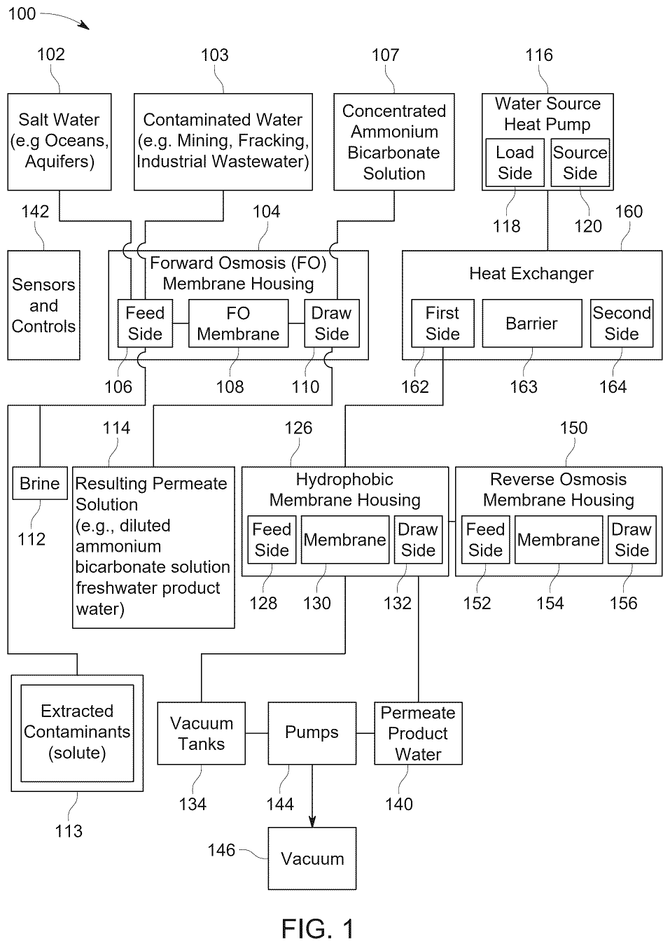

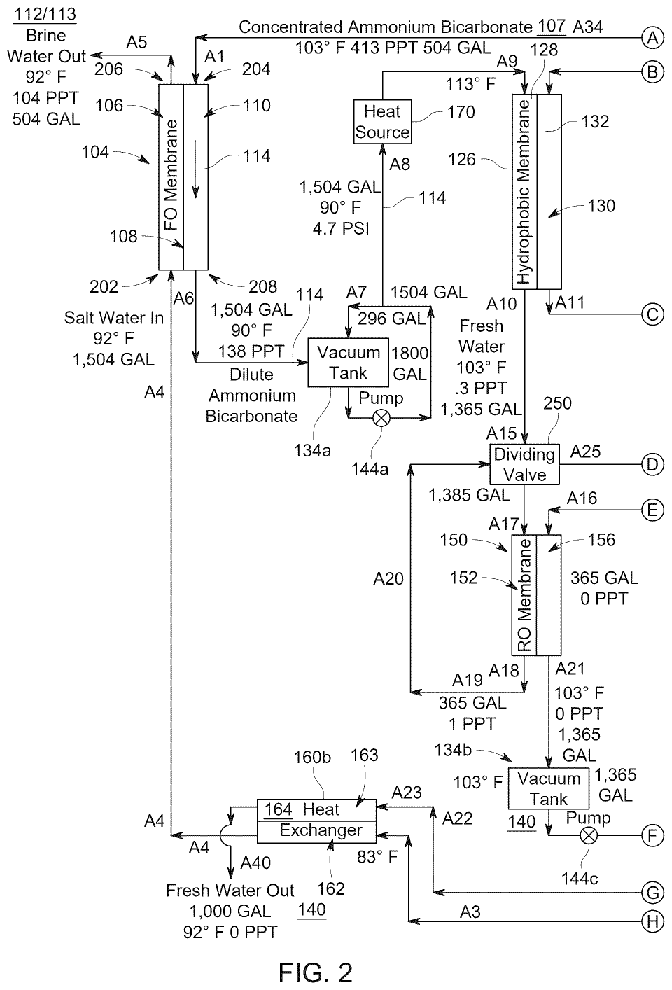

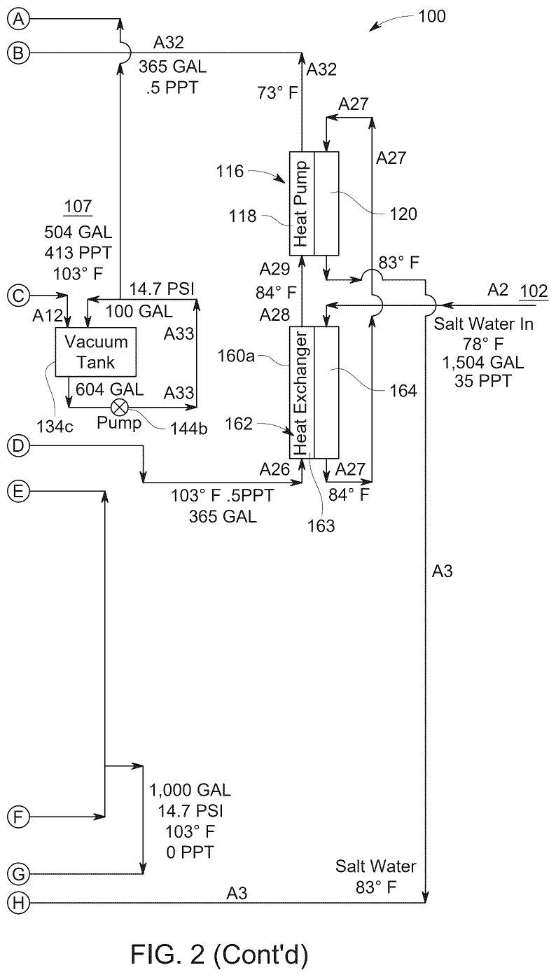

In a non-limiting embodiment, it is believed that the one or more components of the water desalination system (e.g., system 100 as illustrated in FIG. 1 and FIG. 2) may be able to achieve a freshwater recovery rate of 60% or greater. The use of the forward osmosis and reverse osmosis system will greatly reduce energy costs in comparison with traditional methods in part because the present method or system does not require expensive pressure pump systems or heating components and the use of the ammonium bicarbonate as the draw solution is more effective in obtaining a greater amount of freshwater product water for treatment and use.

The method and system as described herein in one or more non-limiting embodiments includes the use of a forward osmosis/hydrophobic membrane/reverse osmosis system to desalinate saltwater (e.g., seawater) or other sources of contaminated water to extract fresh water for later processing and use.

The system described herein offers many positive benefits including a lower energy cost and the fact that little pretreatment is required. Other benefits are 60% or greater of lower water intake and outlet costs, low pressure pumps, low pressure plumbing, and low-pressure membrane housings. Further description is provided with respect to the Figures.

FIG. 1 is a block diagram with one or more components that may be used with the forward osmosis water desalination system 100. FIG. 1 may be viewed in conjunction with the process flow illustrated in FIG. 2 to better understand the overall system 100 according to one or more non-limiting embodiments.

As shown in FIG. 1, water desalination system 100 operates using forward osmosis. Forward osmosis (FO) is a process by which solvent is extracted from solution when the solution is exposed to a forward osmosis (FO) membrane 108 contained in the forward osmosis housing 104. In this instance, the initial solution is either the salt water solution 102 as obtained from any type of salt water source or another type of contaminated water solution 103 obtained from another water source. In a forward osmosis system 100, a feed solution (e.g., salt water 102 or contaminated water 103) is fed through the feed side 106 of the FO membrane housing 104 while a draw solution (e.g. concentrated ammonium bicarbonate solution 107) is fed through the draw side 110 of the FO membrane housing 104. Because the high osmatic draw pressure differences between the draw solution on the draw side 110 of the FO membrane housing 104 and the feed side 106 of the FO membrane housing 108, a percentage or an amount of the water from the salt water solution 102 or from another type of contaminated water solution 103 is pulled through the FO membrane 108 of the FO membrane housing 104, which allows the water 114 pulled into the draw side 110 to be treated and redirected for later use as further explained below with respect to FIG. 2 and FIG. 3.

The saltwater solution 102 may be obtained from any source of salt water including without limitation oceans and deep aquifers. Any other source of water with high levels of salinity may alternatively be used. The contaminated water solution 103 may be obtained from other types of sources where water may usefully be recovered and treated for reuse. For example, other sources of contaminated water 103 include, but are not limited to, any source of brackish water, wastewater, industrial water, mining, or fracking. The system 100 as used herein may be particularly useful in high salinity situations such as mining, fracking, and/or industrial wastewater.

In a non-limiting embodiment, it is intended that the saltwater solution 102 processed via the FO system/water desalination system 100 shown in FIG. 1 and in FIG. 2 may be useful in many instances for providing freshwater including potable drinking water. In some instances, the water processed via the FO system/water desalination system 100 may be processed not solely for drinking water but rather for other useful purposes such as irrigation for farming or industrial use or other purposes to which non-potable water may be used. It is foreseeable that there may be a high demand for the desalinated water 140 produced by the water desalination system and method 100 as described herein and shown in the accompanying FIGS. 1-5.

In a non-limiting embodiment, the FO membrane housing 104 is the device or apparatus which contains the FO membrane 108 which physically divides the feed side 106 of the FO membrane housing 104 from the draw side 110 of the FO membrane housing 104. In a non-limiting embodiment, the FO membrane 108 may be a cellulose triacetate membrane. Any other FO membrane 108 may be useful as long as the FO membrane 108 permits water to pass through the FO membrane 108 and leaving salts as brine 112 and retain the ammonium bicarbonate ions that are used on the draw side 110 of the FO membrane housing 104. In a non-limiting embodiment, the FO membrane housing 104 may be a spiral wound membrane, a hollow fiber membrane, or a flat plate membrane, which are existing types of membrane housing devices that may be used for FO membrane housing 104 and which are produced currently by one or more manufacturers. Other types of FO membrane housing 104 as known in the art may alternatively be used instead of those listed above.

Once the saltwater solution 102 or other type of contaminated water 103 has been processed through the FO membrane housing 104, it is expected that a percentage of brine 112 or other types of extracted water contaminants 113 will be pulled from the outlet 106 of the feed side 106 of the FO membrane housing 104. The brine solution 112 and/or other types of extracted water contaminants 113 can be directed as needed to other storage tanks, processing facilities, disposal sites, and/or collected for later disposal and/or reuse. Brine 112 as used herein may refer to or indicate a high concentration solution of salt and/or other solid particles.

Brine 112 may contain a certain amount of water in the solution, but there is also a concentration of salt or sodium chloride collected in the brine solution 112 which is one of the goals of using the forward osmosis process in system 100. If the contaminated water solution 103 is directed through the FO membrane housing 104, it is possible that other types of extracted contaminants or extracted solutes 113 are collected instead of only or in addition to the collection of the brine 112. Such contaminants may include any solids or solutes found in mining water, industrial water, wastewater, brackish water, or any other source of contaminated water solution 103.

The resulting permeate solution 114 that is pumped out of the outlet 208 of the draw side 108 of the FO membrane housing 104, as shown for example in FIG. 2, should primarily constitute freshwater that has a low or negligible percentage of sodium chloride ions such as that found in brine 112 or other extracted contaminants 113. The resulting permeate solution 114 will also include ammonium bicarbonate ions, such that the resulting permeate solution 114 has a desirable amount of desalinated water and also diluted ammonium bicarbonate ions.

In a non-limiting embodiment, the concentrated ammonium bicarbonate solution 107 may comprise at least 25% ammonium bicarbonate in the concentrated ammonium bicarbonate solution 107. In another non-limiting embodiment, the ammonium bicarbonate may comprise between 25%-30% or 30%-35% in the concentrated ammonium bicarbonate solution 107. In a non-limiting embodiment, the ammonium bicarbonate may comprise 35% of the concentrated ammonium bicarbonate solution 107.

The resulting permeate solution 114 may also be referred to as a diluted ammonium bicarbonate solution as a measurable percentage of the water from the salt water 103 and the contaminated water 103 has had a chance to flow through the FO membrane barrier 108 due to the osmotic draw of the draw solution 107 into the draw side 110 of the FO membrane housing 108. Accordingly, with the additional water pulled over into the draw side 110 of the FO membrane housing 108, the concentrated ammonium bicarbonate solution 107, which is pumped and forced to flow into inlet 204 of the draw side 110 of the FO membrane housing 104, becomes diluted.

In a non-limiting embodiment, when the ammonium bicarbonate is diluted, the resulting permeate solution 114 may comprise between 5-10% of ammonium bicarbonate ions. As discussed later herein with respect to FIG. 2 as well, the ammonium bicarbonate ions are caused to vaporize or dissociate into their respective gases of ammonia, carbon dioxide, and water vapor in the hydrophobic membrane housing 126 due to temperature differences between the feed side 128 of the hydrophobic membrane housing 126 and the draw side 132 of the hydrophobic membrane housing 126.

The end goal of the water desalination system 100 is to produce freshwater product water or permeate product water 140 that can be collected for various purposes that would benefit humanity and industry. The permeate product water 140 may be further treated in order to provide a plentiful source of potable water. The permeate product water 140 may be also be left untreated if needed. The permeate product water 140 may be used for irrigation or agriculture and for various industries.

FIG. 1 shows that the water desalination system 100 may further include various sensors and controls 142. The sensors and controls 142 may be various sensors and controls as known by one of ordinary skill in the art to detect and obtain various relevant measurements for the system 100. The one or more pumps 144 are utilized to pump fluid from one point to another in the system 100 as shown for example in FIG. 2. In a non-limiting embodiment, a sensor and controller 142 may be needed to detect various temperatures, including the temperature of salt water 102 and/or contaminated water 103, the temperature of the concentrated ammonium bicarbonate solution 107, and/or the temperature of the resulting permeate solution 114, as well as the temperature of the feed solution for the feed side 128 of the hydrophobic membrane housing 126 and the temperature of the solution entering the draw side 132 of the hydrophobic membrane housing 126. Other temperatures may be read and detected as well in order to adjust one or more variables for the water desalination system 100.

In a non-limiting embodiment, the system 100 utilizes a water source heat pump 116. FIG. 1 shows an exemplary pictorial illustration of a water heat pump 116. The water source heat pump 116 is not an air to air source heat pump, but rather is designed to allow water and fluid to flow through the heat pump 116 in order to be heated or cooled. The water source heat pump 116 includes a load side 118 and a source side 120, which is further discussed with respect to FIG. 2. The water heat pump 116 further comprises additional equipment conventionally used with a water heat pump, such as a compressor, a refrigerant (e.g. Freon), an expansion valve, in order to extract heat from the water flowing into the source side 120 of the heat pump 116 and transfer that heat to the water flowing into the load side 118 of the heat pump 116.

In a non-limiting embodiment, the water desalination system 100 further includes one or more dividing valves 250 which act to divide flow of the desalinated water/permeate solution 114 and/or other sources of solution and water, including freshwater or permeate product water 140 throughout the water desalination system 100.

The water desalination system 100 may further include one or more vacuum tanks 134 (e.g. 134a, 134b, 134c). The purpose of the vacuum tanks 134 is to maintain a partial vacuum in the system and ambient pressure throughout the remainder of the system. In other words, the vacuum tanks 134 allow for a one-time vacuum pull or the initial creation of a partial vacuum that can be maintained by pumping a higher volume of water back into the vacuum tank 134 than is existing the system.

The water desalination system 100 may further include a hydrophobic membrane housing 126. The hydrophobic membrane housing 126 includes a feed side 128, a hydrophobic membrane 130, and a draw side 132. FIG. 1 shows an exemplary pictorial illustration of a hydrophobic membrane housing 126. Notably, the term “hydrophobic” indicates that the hydrophobic membrane housing 126 includes a hydrophobic membrane 126 capable of repelling water or preventing water from flowing through the hydrophobic membrane 126. The hydrophobic membrane 130 in the hydrophobic membrane housing 126 does permit the flow of gases, however, through the hydrophobic membrane 130. This may be relevant as the ammonium bicarbonate ions are made to disassociate into gas form as ammonia, carbon dioxide, and water vapor within the feed side 128 of the hydrophobic membrane housing 126 and these gases are able to travel through or flow through the membrane 130 of the hydrophobic membrane housing 126 into the draw side 132 of the hydrophobic membrane housing 130. Further information about this process is provided below with respect to FIG. 2.

The hydrophobic membrane 130 may be made of PTFE (polytetrafluoroethylene) in a non-limiting embodiment. PTFE is a coated woven fiberglass membrane that is considered extremely durable. In another non-limiting embodiment, the hydrophobic membrane 130 may be made of polyvinylidene fluoride (PVDF). Both types of membranes, whether PTFE or PVDF, are intended to be hydrophobic and not allow water to flow through the membrane 130 itself, but the water solution can still flow into and out of the feed side 128 and the draw side 130 of the hydrophobic membrane housing 126. The term “housing” as used herein refers to the apparatus or device container that contains the membranes 108 or 130.

It is noted, that the FO membrane 108 in the FO membrane housing 104 shown in FIG. 1 and in FIG. 2 is hydrophilic and can allow water flow to flow through the FO membrane 108 and is not a hydrophobic membrane.

In a non-limiting embodiment, the water desalination system 100 requires a vacuum 146 to be created and maintained during the water desalination process 100 and pumping out of the freshwater/product water 140. In a non-limiting embodiment, one method of producing a vacuum 146 is to activate at least one vacuum pump 136 as needed. The water desalination system 100 may further utilize another vacuum tank 134b, which acts as a reservoir or collection tank for the product water 140 and is also pictured in FIG. 2.

Turning to FIG. 2, FIG. 2 provides a pictorial flowchart of a method for desalinating salt water 102 or other contaminated water 103 according to one or more non-limiting embodiments. In a non-limiting embodiment, it may first be useful for the vacuum 146 to be created. The vacuum 146 may be created by turning on at least one or more vacuum pumps 136. In a non-limiting embodiment, it may be useful for a vacuum tank 134 in the water desalination system 100 to include an initial amount of concentrated ammonium bicarbonate 107 that helps to balance the pressure and flow in the water desalination system 100 upon commencement and creation of the vacuum 146.

The water desalination system 100 may begin with vacuum tank 134a being partially filled with an initial amount of diluted ammonium bicarbonate solution 114 and the vacuum tank 134b being filled with an initial amount of concentrated ammonium bicarbonate solution 107. Further, the source side 120 of the water heat pump 116 is also filled with water.

Next, the process may begin by pumping and flowing an amount of salt water 102 or contaminated water 103 from one or more sources (e.g., oceans, aquifers, contaminated water sources) into an inlet 202 of the feed side 106 of the FO membrane housing 104. At the same time or approximately simultaneously, an amount of concentrated ammonium bicarbonate 107 is also pumped into an inlet 204 of the draw side 110 of the FO membrane housing 104. Because the ammonium bicarbonate in the concentrated ammonium bicarbonate solution 107 acts as a powerful osmotic draw solution, a high percentage of the water contained in the salt water 102 and/or contaminated water 103 flowing through the feed side 106 of the FO membrane housing 104 is caused to flow cross ways through the permeable membrane 108 of the FO membrane housing 104 and into the draw side 110 of the FO membrane housing 104 as part of the forward osmosis process.

In a non-limiting embodiment, brine 112 emerges from an outlet 206 of the feed side 106 of the FO membrane housing 104 when the salt water 102 is the feed solution. In other non-limiting embodiments, other extracted contaminants 113 may be pulled out of or pumped out of the outlet 206 of the feed side 106 of the FO membrane housing 104 when other sources of contaminated water 103 are fed through or directed through the feed side 106 of the FO membrane housing 104.

As part of the forward osmosis process, the resulting permeate solution 114 is allowed to flow out of the outlet 208 from the draw side 110 of the FO membrane housing 104. As shown in FIG. 2 and as referred to herein, the resulting permeate solution 114 may also be referred to as the diluted ammonium bicarbonate solution in that the resulting permeate solution 114 has a diluted amount of ammonium bicarbonate ions/compounds in comparison with the concentrated ammonium bicarbonate solution 107 which acted as the draw solution initially in the draw side 110 of the FO membrane housing 104. As noted above, in a non-limiting embodiment, the percentage of concentrated ammonium bicarbonate ionic compounds may be approximately 25-35% whereas the percentage of diluted ammonium bicarbonate ionic compounds may have been reduced to 5-10% after the additional water is pulled into the draw side 110 of the FO membrane housing 104 from the flowing salt water 102 and/or contaminated water 103.

It is expected that in one or more non-limiting embodiments, about 30-40% of brine 112 is extracted and made to flow from the outlet 206 of the feed side 106 of the FO membrane housing 104, whereas about 60-70% of the resulting permeate solution 114 is made to flow from the draw side 108 of the FO membrane housing 104. This is considered a higher draw result than systems that use reverse osmosis (RO) as their method of osmosis, because RO systems tend to only be able to obtain about 40-45% of freshwater, product water 140, whereas the water desalination system 100 using ammonium bicarbonate as the draw solution and forward osmosis as shown in herein is expected to yield 60-70% of freshwater, useable product water 140.

FIG. 1 shows that there is also a heat source 170 utilized in the system 100 for desalination or production of permeate product water/fresh water 140. In a non-limiting, the heat source 170 may be any location that emits waste heat or existing heat. This may include power plants, such as natural gas, biomass, nuclear, coal, or oil power plants. This may include industrial power plants that use industrial processes and are fueled by natural gas, biomass, coal, oil, and/or electricity. It may be useful to obtain the waste heat from a power plant or another industrial source for additional energy savings. Additionally, the heat source 170 may be geothermal wells that give off heat that may be utilized as a heat source 170 to raise the temperature of the diluted ammonium bicarbonate 114. In a non-limiting embodiment, the desalination system 100 can be sited near an ocean, a land-based well, or another industrial processing facility. Alternatively, a dedicated power plant may be built as the heat source 170 to supply power and provide waste heat for the desalination process 100. This may also provide significant energy and equipment costs savings compared to traditional FO (forward osmosis) and RO (reverse osmosis) systems.

The system 100 further utilizes a heat pump 116. The heat pump 116 has a load side 118 and a source side 120. In a heat pump, such as heat pump 116, the load side 118 refers to the area or space where the heat is ultimately delivered, while the source side 120 is where the heat is extracted from. Essentially, the heat pump 116 moves heat from the source side 120 to the load side 118.

The system 100 further utilizes a hydrophobic membrane housing 126. The hydrophobic membrane housing 126 includes a feed side 128, a membrane 130, and a draw side 132. The hydrophobic membrane 130 is used to filter out the ammonium bicarbonate as a gas. The hydrophobic membrane 130 acts as a barrier to the liquid in the diluted ammonium bicarbonate. Thus, the ammonium bicarbonate ions flow through the membrane 130 and into the draw side 132 of the hydrophobic membrane housing 126. Meanwhile, the liquid water is allowed to flow out of the feed side 128 of the hydrophobic membrane housing 126. Hydrophobic membranes 130 excel at filtering gases because gases, being non-polar, can easily pass through the membrane 130's pores.

The system 100 further utilizes a reverse osmosis (RO) membrane housing 150. For reverse osmosis to occur, pressure is applied to the high-concentration side or the feed side 152, exceeding the osmotic pressure. This forces water molecules to move against their natural tendency, from the concentrated solution containing contaminants to the less concentrated side (in the draw side 132), containing purified water. The RO membrane housing 150 includes a semi-permeable membrane 154 that acts as a filter, allowing only water molecules to pass through while trapping larger contaminants such as any remaining ammonium bicarbonate ions. This results in purified water exiting one side (at A21 from the draw side 156 of the RO membrane housing 150) and a more concentrated fluid stream on the other (at A18 exiting from the feed side 152 of the RO membrane housing 150). Accordingly, the fresh water directed from the hydrophobic membrane housing 126 (e.g. as shown in FIG. 2) is directed through a dividing valve 250 and then into the feed side 152 of the RO membrane housing 150 in order for the reverse osmosis process to cause the ammonium bicarbonate ions to remain in the feed side while the resulting permeate solution/purified water 114 is able to exit and flow out of the draw side 154 of the RO membrane housing 150.

The system 100 further utilizes one or more vacuum tanks 134 and pumps 144 as well as may utilize one or more sensors and controls 142.

Further, the system 100 utilizes one or more heat exchangers 160, as shown for example in FIG. 2. A heat exchanger 160 works by transferring thermal energy between two or more fluids (liquids or gases) without direct mixing. It achieves this by using a barrier 163, often a metal wall, to separate the fluids while allowing heat to pass through from a first side 162 to a second side 164. The transfer occurs due to the temperature difference between the fluids, with heat flowing from the hotter fluid to the colder one. The heat exchangers 144 shown in FIG. 2 include a first side 162 and a second side 164 separated by a barrier 163 in between the first side 162 and the second side 164.

The system 100 as shown in FIG. 1 includes at various steps in the desalination process “resulting permeate solution” which includes diluted ammonium bicarbonate solution, which is a mixture of water and ammonium bicarbonate. The end result of the desalination system or process 100 is a fresh water product or permeate product water 140 containing useable, fresh water that may be used as potable water (upon possible further treatment) and which includes no or very minimal traces of ammonium bicarbonate.

Turning to FIG. 2, FIG. 2 is an exemplary pictorial illustration of a method of desalination using one or more components as identified and shown in the block diagram in FIG. 1. At step A1 in FIG. 2, concentrated ammonium bicarbonate 107 is directed to the inlet 204 of the draw side 110 of the FO membrane housing 104, while at step A4, the salt water 102 is directed into the inlet 202 of the feed side 106 of the FO membrane housing 104. Salt water 102 has a high concentration of salt in water and may be obtained from an ocean. Alternatively, contaminated water 103 (e.g. mining, fracking, or industrial wastewater) may be directed into the inlet 202 of the feed side 106 of the FO membrane housing 104 instead of salt water 102.

While in the FO membrane housing 104, a large percentage of water contained in the salt water will flow through the permeable membrane 108 of the FO membrane housing 104 due to the osmotic draw effect of the concentrated ammonium bicarbonate solution flowing through the draw side 110 of the FO membrane housing 104. The resulting effect is that the concentrated ammonium bicarbonate 107 mixes with the water flowing into the draw side 110 of the FO membrane housing 104 to yield a diluted ammonium bicarbonate solution 114 that exists out of the outlet 208 of the FO membrane housing 104 as shown at step A6 in FIG. 2.

As shown at step A1, the concentrated ammonium bicarbonate 107 when flowing into the inlet 204 of the draw side 110 of the FO membrane housing 104 may have a temperature at approximately 103 degrees Fahrenheit and may be approximately about 504 gallons and may include 413 parts per thousand (PPT) of ammonium bicarbonate. When exiting the outlet 208 of the draw side 110 of the FO membrane housing 104, the diluted ammonium bicarbonate 114 may have a reduced temperature of 90 degrees Fahrenheit. The amount of solution 114 increases from the initial 504 gallons to approximately 1,504 gallons. The amount of ammonium bicarbonate present in the diluted ammonium bicarbonate solution 114 may be approximately 138 PPT. As noted above, the intended purpose of the use of the FO membrane housing 104 is to cause the draw of water from the salt water 102 via the permeable membrane 108 of the FO membrane housing 104 into the draw side 110 in order to then further desalinate that resulting solution 114 or decontaminate of unwanted solutes.

Simultaneously, or subsequently, brine 112 or extracted contaminants/solute 113 are directed out of the outlet 206 of the feed side 106 of the FO membrane housing 104 as shown at step A5 in FIG. 2.

Notably, the incoming salt water 102 shown at step A2 in FIG. 2, is at 78 degrees Fahrenheit. The system 100 requires that the temperature of the salt water 102 be raised or increased. In a non-limiting embodiment, the system 100 may direct the salt water 102 through a side 164 of the heat exchanger 160a. At step A27, the heated salt water 102 is approximately 84 degrees Fahrenheit, as shown in FIG. 2, and directed from the heat exchanger 160 at 84 degrees Fahrenheit into the source side 120 of the heat pump 116. In a non-limiting embodiment, the temperature of the salt water 102 may drop a minimal amount such as by 1 degree to become approximately 83 degrees as shown in FIG. 2. At step A3, the salt water 102 is then directed at 83 degrees through one of the sides (e.g. side 164) of heat exchanger 160b prior to directing the salt water 102 (or contaminated water 103) into the feed side 106 of the FO membrane housing 104. As shown at step A4, the temperature of the salt water 102 directed out of the heat exchanger 160b and into the feed side 106 of the FO membrane housing 104 at 92 degrees Fahrenheit. Thus, the exemplary process shown in FIG. 2 functions by having the heat exchanger 160a initially heat the incoming salt water 102 and then directs the salt water 102 into the heat pump 116 which helps to provide efficiency with other processes as further discussed later below. It is noted that the salt water 102 may enter the heat exchanger at step A2, at approximately 1,504 gallons and with 35 parts per thousand of ammonium bicarbonate present in the incoming salt water.

Returning to step A6, the diluted ammonium bicarbonate 114 is directed to a vacuum tank 134a and pumped via pump 144a one or more times in and out of the vacuum tank 134a as shown at step A7. Pumping the incoming diluted ammonium bicarbonate 114 one or more times helps to maintain the partial vacuum for system 100. Notably, it is important to have greater water flow and pressure than in the atmosphere to maintain the partial vacuum without having to also utilize a vacuum pump as part of the system. The vacuum tanks 134 ensure that the water can be pumped into and out of the vacuum tanks and then redirected where it is needed, while preserving the partial vacuum in the system 100, without having to utilize a vacuum pump. At step A7, there may be 1,504 gallons of dilute ammonium bicarbonate 114 directed into the vacuum tank 134a. About 1800 gallons of the dilute ammonium bicarbonate 114 are pumped via pump 114a out of vacuum tank 134a and 1504 gallons are directed into the heat source 170 at step A8 at 90 degrees Fahrenheit, 4.7 psi as shown in FIG. 2 while 296 gallons are returned or pumped back into the vacuum tank 134a. Accordingly, the vacuum tank 134a consistently has water inside it so as to assist in pumping in and out of the vacuum tank 134a more water to maintain a partial vacuum.

At step A8, the diluted ammonium bicarbonate 114 is directed from the vacuum tank 134a to an inlet of a heat source 170 to be heated from the 90 degrees Fahrenheit to 113 degrees Fahrenheit. As noted above, the heat source 170 can be a variety of sources that can heat a solution such as the diluted ammonium bicarbonate solution 114. This may include a heat pump in some circumstances or it may siphon off the waste heat of an existing processing plant, a geothermal well, or another source of heat without limitation. It is noted that between step A7 and A8, the diluted ammonium bicarbonate solution 114 may be directed to be heated by a heat source 170 at 1504 gallons and with a pressure of 4.7 psi (pounds per square inch).

At step A9, the diluted ammonium bicarbonate solution 114 is directed into the inlet of the feed side 128 of the hydrophobic membrane housing 126 at a much higher temperature (e.g. 113 degrees Fahrenheit). Simultaneously, cooler water is directed into the inlet of the draw side 132 of the hydrophobic membrane housing 126. The cooler water may be approximately 73 degrees Fahrenheit. Thus, the diluted ammonium bicarbonate solution 114 flowing into the inlet of the feed side 128 of the hydrophobic membrane housing 126 is higher than the water solution flowing into the draw side 132 of the hydrophobic membrane housing 126. Due to the heat being dissipated and the temperature differential and the fact that the water desalination system 100 is maintained under a vacuum, the ammonium bicarbonate ions in the resulting permeate solution 114 vaporize or disassociate into their respective gas form of ammonia, carbon dioxide, and water vapor. The gases (e.g., ammonia, carbon dioxide, and water vapor) can permeate cross-ways through the hydrophobic membrane 130 of the hydrophobic membrane housing 126 into the draw side 132 of the hydrophobic membrane housing 126. The disassociation process that occurs due to temperature differences and orientation of the solution 114 with respect to the cooler water flowing into the draw side 132 of the hydrophobic membrane housing 126 functions to remove the ammonium bicarbonate ions from the resulting solution 114 so that fresh product water 140 can flow out of the outlet of the feed side 128 of the FO membrane housing 126 without any or with a reduced amount of ammonium bicarbonate ions in the product water 140 that can be further produced and treated for later use. Thus, the temperature difference and the hydrophobic membrane 130 of the hydrophobic membrane housing 126 is used as a means to remove the ammonium bicarbonate ions from the freshwater product 140. The heat causes the ammonium bicarbonate ions present in the diluted ammonium bicarbonate solution 114 to convert into gases (e.g. CO₂ and HNH₃) leaving permeate water 140 behind.

As shown at step A10, the fresh water product 140 exits the feed side 128 of the hydrophobic membrane housing 126 at approximately 103 degrees Fahrenheit in the amount of 1,365 gallons with 0.3 PPT of ammonium bicarbonate ions. At step A11, the water temperature exiting the draw side 132 of the hydrophobic membrane housing 126 has been raised to 103 degrees and has 413 PPT of ammonium bicarbonate ions in the existing solution with about 504 gallons exiting the draw side 132.

At step A15, the product water 140 containing a negligible amount of ammonium bicarbonate is directed into a dividing valve 250. The dividing valve 250 functions to direct a first amount of the fresh product water with negligible amount of ammonium bicarbonate 140 towards a reverse osmosis (RO) membrane housing 150. A second of the fresh product water 140 is directed from the dividing valve 250 towards the heat exchanger 160a as shown at step A25 and A26.

At step A16, the permeate product water 140 is directed from the dividing valve 250 into the feed side 152 of the RO membrane housing 150. At step A17, in a non-limiting embodiment, about 1,365 gallons of the permeate product water 140 is directed from the dividing valve 250 (after having passed through the hydrophobic membrane housing 126) and into the feed side 152 of the RO membrane housing 150. At step A16, additional water is allowed to flow through the draw side 156 of the RO membrane housing 150. The additional water may be about 365 gallons with 0 PPT of ammonium bicarbonate ions that is allowed to flow into the inlet of and through the draw side 156 of the RO membrane housing 150 while the product water 140 is flowing through the feed side 152 of the RO membrane housing 150. The additional water flowing through the draw side 156 of the RO membrane housing 150 enters the draw side 156 at a higher pressure than the pressure of the permeate water 140 flowing through the feed side 12 of the RO membrane housing 150. As shown in FIG. 2, in a non-limiting embodiment, the pressure may be at 14.7 psi and also at 103 degrees Fahrenheit.

Accordingly, the higher pressure draw side 156 of the RO membrane housing 150 causes the remaining negligible amount of ammonium bicarbonate ions to be retained in the feed side 152 while additional fluid/cleaner water is drawn through the hydrophilic membrane 154 of the RO membrane housing 150 having ideally no ammonium bicarbonate ions remaining in the product water 140 flowing out of the outlet of the draw side 156 of the RO membrane housing 150. At step 21 in FIG. 2, in a non-limiting embodiment, the product water 140 exiting the draw side 156 of the RO membrane housing 150 may be at 103 degrees Fahrenheit with zero PPT of ammonium bicarbonate present and may comprise about 1,365 gallons.

Upon exiting the draw side 156 of the RO membrane housing 150, the product water 140 is directed into vacuum tanks 134b at step A22. The product water 140 is pumped via pump 144c through the vacuum tank 134b and out at 1000 gallons and 14.7 PSI, with no ammonium bicarbonate ions left at 103 degrees Fahrenheit and directed to the heat exchanger 160b (e.g. side 164) at step A23. In a non-limiting embodiment, approximately 1,365 gallons is pumped into the vacuum tank 134b from the RO membrane 150 and 1,365 gallons are pumped out of the vacuum tank 134b. At reference number in FIG. 2, 1000 gallons may be pumped at 14.7 PSI and 103 degrees Fahrenheit to the heat exchanger 160b at A22 and A23 and reference number G as shown in FIG. 2. As shown in FIG. 2, upon passing through the heat exchanger 160b via side 164b, the fresh product water 140 exits out of the heat exchanger at A40. The fresh product water 140 may receive further treatment and processing for end use. It is intending that the exiting fresh product water 140 at step A40 has no ammonium bicarbonate ions left and that the ammonium bicarbonate ions retained in the feed side 152 of the RO membrane housing 150 are directed back into the system 100 and reused if possible.

Returning to the RO membrane housing 150 exiting the feed side 152 of the RO membrane housing 150, (e.g. at step A18 in FIG. 2), an amount of product water 140 is directed back into the dividing valve 250 at A19 and A20 and out of the dividing valve 250 at A25. The divided and directed product water 140 may be at 365 gallons and have about 1 PPT of ammonium bicarbonate for reuse in the desalination process 100. This amount of product water 140 is directed, at step A26, into side 162 of heat exchanger 160a. The amount of product water may be 365 gallons having a temperature of about 103 degrees Fahrenheit with about 0.5 PPT ammonium bicarbonate including in the directed product water 140 having negligible amounts of ammonium bicarbonate. At A26, the directed product water 140 is directed into and through the side 162 of the heat exchanger 160a and at step 28, the product water 140 exits the outlet of the side 162 of the heat exchanger 160a having a higher temperature. As shown in FIG. 2, this temperature may be at 84 degrees Fahrenheit. The water 140 proceeds into the load side 118 of the heat pump 116 at step A29. The water is directed through the load side 118 of the heat pump 116 and loses some heat, thereby exiting the load side 118 of the heat pump 116 at 73 degrees Fahrenheit at step A32. At step A32, the product water 140 still is about 365 gallons and has 0.5 PPT ammonium bicarbonate. The water 140 is directed into the draw side 132 of the hydrophobic membrane housing 126 at A32 and exits out of the outlet of the draw side 132 of the hydrophobic membrane housing 126 at step A11 at a higher temperature.

As shown in FIG. 2, the original amount of water had 0.5 PPT of ammonium bicarbonate when entering the inlet of the draw side 132 of the hydrophobic membrane housing 126 and exits after the hydrophobic membrane housing 130 allows the ammonium bicarbonate ions contained in the diluted ammonium bicarbonate solution 114 flowing through the feed side 128 of the hydrophobic membrane housing 126 to then pass through and the membrane 130 of the hydrophobic membrane 130 as a gas and then reform into solid particles upon exiting the draw side 132 of the hydrophobic membrane hosing 126. Upon exiting the outlet of the draw side 132 of the hydrophobic membrane housing 126, there is a much higher amount of ammonium bicarbonate contained in the exiting solution so as to become a concentrated ammonium bicarbonate solution 107. FIG. 2 illustrates that it may be at 413 PPT of ammonium bicarbonate and the temperature has been raised to 103 degrees Fahrenheit at step A11. At step A12, the existing solution of concentrated ammonium bicarbonate solution 107 is directed into vacuum tank 134c and pumped (e.g. via pump 144b) around one or more times. The vacuum tank 134c may already include 100 gallons and this is added to the concentrated ammonium bicarbonate solution 107 which is pumped by pump 144b out of and into the vacuum tank 134c one or more times as shown at step A33. At step A34, about 504 gallons are directed (e.g. at a pressure of 14.7 psi) to the draw side 110 of the FO membrane housing 104 (e.g. A34 to A1). In this manner, the concentrated ammonium bicarbonate solution 107 is reused and recycled by the desalination system/process 100.

It is noted that when the ammonium bicarbonate ions from the heated resulting permeate solution 114 (e.g. flowing through the inlet of the feed side 128 of the hydrophobic membrane housing 126) disassociate into gases that permeate through the hydrophobic membrane 130 of the hydrophobic membrane housing 126, the gases pass to the draw side 132 where the gases reassociate and condense back into ammonium bicarbonate ions. The resulting solution having the condensed ammonium bicarbonate ions passes through the outlet of the draw side 132 of the hydrophobic membrane housing 126 and the solution is directed to the vacuum tank 134c in a non-limiting embodiment, and pumped back to the inlet of the draw side 110 of the FO membrane housing 104. In this manner, the same ammonium bicarbonate ions are utilized in a circular manner and forced to dissociate and reassociate or condense in the same hydrophobic membrane housing 126 due to differences in temperature of the ammonium bicarbonate solution 114 in the feed side 128 of the hydrophobic membrane housing 126 as compared with the cooler water flowing into and through the draw side 132 of the hydrophobic membrane housing 126. Further, the disassociation process gives off latent heat which helps to cool the solution contained in the draw side 132 of the hydrophobic membrane housing 126 and for the ammonium bicarbonate ions to condense and reform on the draw side 132 of the hydrophobic membrane housing 126.

The temperature difference in the hydrophobic membrane housing 126 is a driving force that passes the ammonium bicarbonate gases through the hydrophobic membrane 130. Further, generally the same water from the dilute solution 114 and from the product water 140 is recycled through the system 100 and the water heat pump 116 as the load and source of heat.

Notably, because the water desalination system 100 is maintained at a partial continuous under a vacuum 146, the temperature that the ammonium bicarbonate ions disassociate to become gases (e.g., ammonia, carbon dioxide, and water vapor) is lower in a vacuum 146 than the temperature that would be required for the ammonium bicarbonate ions to disassociate when a vacuum 146 is not maintained. This is one of the reasons why the water desalination system 100 shown in FIG. 1 and in FIG. 2 requires less energy.

In a preferred non-limiting embodiment, the temperature of the salt water 102 and/or contaminated water 103 flowing into the feed side 106 of the FO membrane housing 104 may be obtained from the temperature of the hydrophobic membrane 126. Likewise, the temperature of the concentrated ammonium bicarbonate 107 flowing into the draw side 110 of the FO membrane housing 104 may also be regulated via one or more sensors and controls 142 to be the same temperature as the hydrophobic membrane 126. When the resulting solution 114 exits at the outlet 208 of the draw side 110 of the FO membrane housing 104, the temperature of the resulting solution 114 has not been raised by the forward osmosis process that occurred in the FO membrane housing 104. As such the temperature of the resulting permeate solution 114 is the same and at ambient temperature as the temperature of the incoming solutions into the feed side 106 and the draw side 110 of the FO membrane housing 104. The temperature of the resulting solution 114 when entering the inlet 210 of the load side 118 of the water heat pump 116 is also at ambient temperature. However, the temperature of the resulting solution 114 is raised and heated so that the temperature of the resulting solution 114 (or diluted ammonium bicarbonate solution) is higher than ambient temperature after flowing through the load side 118 of the water heat pump 116 and when exiting at the outlet 212 of the load side 118 of the water heat pump 116. The temperature of the heated resulting solution 114 may not be significantly higher but may be in the range of 10-15 degrees higher than ambient temperature in one or more non-limiting embodiments.

It is noted that the temperature of the resulting permeate solution 114 has to be lowered to a minimum threshold level of 70 degrees Fahrenheit for the ammonium bicarbonate ions to disassociate into gases when in a vacuum 146. Thus, when the diluted ammonium bicarbonate solution 114 is directed through the feed side 128 of the hydrophobic membrane housing 126, the diluted ammonium bicarbonate solution 114 must be maintained at that minimum threshold level for the vaporization or disassociation to occur. The minimum threshold level for ammonium bicarbonate ions to fully dissociate may be from 156 F with no vacuum down to 70 Fahrenheit under a very high or deep vacuum 146. In a non-limiting embodiment, the range of the vacuum 146 may be between. 5 to 2.0 psi.

Notably, if the water desalination system 100 was not maintained in a vacuum 146, the minimum threshold temperature level to cause the ammonium bicarbonate ions in the diluted ammonium bicarbonate solution/resulting permeate solution 114 to disassociate into gases would be much higher. For example, the minimum threshold level when not under a vacuum would be approximately 156 Fahrenheit, which would require greater energy loads and heating by the water heat pump 116. As such, it is an advantage that the vacuum 146 is continuously maintained in the water desalination system 100 and the minimum threshold level for the ammonium bicarbonate ions to disassociate into their respective gases is lower such that the temperature of the diluted ammonium bicarbonate solution 114 passing through the inlet of the feed side 128 of the hydrophobic membrane housing 126 is not as high as when a vacuum 146 is not continuously maintained. This directly translates into savings in cost for not having to heat the solution 114 as high as would be required if a vacuum 146 is not maintained in a non-limiting embodiment.

Several advantages exist with respect to the system and method 100 shown in FIG. 1 and FIG. 2 and as described above. Notably, the use of the FO membrane housing 104 allows for the use of ammonium bicarbonate which has a powerful osmotic pressure draw. The system 100 is relatively low-cost due to the use of the hydrophobic membrane housing 126 which uses a differential temperature membrane 130 as a pathway to low-cost draw recovery. Further, as the intended goal is for the exiting product water to be clean potable water as a final product, the use of the low-pressure reverse osmosis to remove any residual ammonium bicarbonate and recycle the residual ammonium bicarbonate into the system 100 is desirable to provide a cleaner final product.

In a non-limiting embodiment, there may be significant advantages in draw recovery as offered by the system 100. Only 13.8 percent of solution is ammonium bicarbonate, which is a relatively small amount to then have to remove prior to directing out the clean potable water 140. Further, there is a low latent heat with disassociation (e.g. 121 vs water at 1000 btu/lb to vaporize). Further, there are zero azeotropes with dissociation, unlike ethanol. This means that 100 percent can be removed without further processing. Further, the ammonium bicarbonate disassociates into gases at relatively low pressures and temperatures.

The reverse osmosis is an effective way to try and remove the last residual amount of ammonium bicarbonate out of the draw water during draw recovery. The reverse osmosis process that uses the RO membrane housing 104 may have very low osmotic pressure, very low energy, low-cost housings, pumps, and membranes.

The system 100 further recaptures most of the latent heat in the hydrophobic membrane housing 126. If the heat pump 116 is a low lift heat pump, this will be an efficient type of pump that provides the cooling needed for the temperature difference to be established in the system 100. A partial vacuum lowers the temperature for the ammonium bicarbonate disassociation to occur. The heat exchangers, such as heat exchangers 160a an 160b, recover a considerable amount of heat. The system 100 further provides for many possible low cost heat sources.

The proposed draw solution of ammonium bicarbonate has these characteristics. The ammonium bicarbonate solution 107 has a high osmotic pressure potential. This is due to many reasons including the following. First, the mole weight of ammonium bicarbonate is 96.09 vs sodium chloride of 58.43, which is therefore 1.6 times higher. This alone increases osmotic pressure of solutions of ammonia bicarbonate over sodium chloride. Second, there are 2 ammonium bicarbonate ions disassociated compared to 2 ions disassociated with sodium chloride. The number of ions disassociated is used as the van′t Hoff factor in computing osmotic pressure. In this case osmotic pressure is the same. Third, the temperature needs to be increased later on to recover the ammonium bicarbonate ions from the permeate water 140. This increases osmotic pressure by close to 1.02 times. Fourth, the maximum solubility of ammonium bicarbonate in water at 86 degrees Fahrenheit is 277 grams/liter whereas seawater/saltwater 102 is 35 grams/liter, 8 times greater. This high concentration of ammonium bicarbonate makes it a powerful draw solution. Fifth, the combination of higher mole weight, same number of ions, higher temperatures, and high solubility in water using ammonium bicarbonate gives it an exceedingly high osmotic pressure and powerful draw solution for use in forward osmosis. Maximum osmotic pressure is about 284 atmospheres compared to 29 atmospheres for seawater/saltwater 102.

Another reason why ammonium bicarbonate has high osmotic pressure potential is that the vaporization temperature of ammonia bicarbonate begins to disassociate at 107 degrees Fahrenheit and fully disassociates at 156 degrees Fahrenheit at standard pressure and can disassociate at as low as 70 degrees Fahrenheit under a vacuum 146. This is far less than the vaporization temperature of water of 212 degrees Fahrenheit of water.

Another reason why ammonium bicarbonate has high osmotic pressure potential is that one does not need to vaporize all the permeate water like most heat methods of desalination currently do. Only the remaining amount of ammonia carbonate in the permeate water needs to be vaporized. This amounts to about 5 to 10% of dilute ammonium bicarbonate solution vs 100% is vaporization of all the permeate water. This saves an enormous amount of latent heat.

An additional reason why ammonium bicarbonate has is that the latent heat is easy to recover and is almost 100%. When ammonium bicarbonate solution dissociates with heat, it creates carbon dioxide, ammonia, gases and water vapor. This is an endothermic reaction that cools the remaining water and places latent heat into the carbon dioxide and ammonia gases. The remaining water is the permeate water.

When the gases cool, they become ammonium bicarbonate ions, and are mixed with water, and the latent heat is recaptured, which helps to warm the newly reconstituted ammonium bicarbonate concentrated solution 107. This is known as an exothermic reaction. This reconstrued concentrated ammonium bicarbonate solution 107 is then fed back to the FO membrane 108 to start the desalination forward osmosis process again as shown in FIG. 2. Only a small portion of the latent heat is lost because it is recovered. The chemistry for this reaction is shown below.

Additionally, another important advantage is that there may be less need to pre-filter the feed seawater or salt water 102. Because the pressures are so low, the feed seawater or saltwater 102 (and/or contaminated water 103) is much more forgiving from fouling the membranes 108 of a FO membrane housing 1204 than for a reverse osmosis system.

Additional advantages include lower plumbing/pump capital cost. The low pressures of a forward osmosis water desalination system 100 allow for low-pressure pumps, pipes, valves, meters, and membrane housings at a substantially reduced cost. In addition, these costs can be spread over more fresh water produced, which is 60% for the forward osmosis system versus the 40% water yield obtained from existing reverse osmosis systems.

An additional advantage is the lower cost of water intake and outlet capital costs. The same capital cost of water intake and outtakes can be spread over a higher volume of fresh water produced.

Additionally, a second stage can increase fresh product water to 76% or higher. By running the brine water 112 into a duplicate and separate forward osmosis system the fresh product water produced can go from 60% to 76% or higher, and the brine water goes up to about 140 ppm.

The water desalination system 100 may be notably beneficial for the use of its low energy cost and high efficiency water heat pump 116 and forward osmosis process 100 shown in FIG. 1 and in FIG. 2. It may be useful to site any water desalination plants or factories that use the process 100 shown in FIGS. 1-5 near warm ocean water when possible, including, locating in the Middle East, Africa, Florida, and other locations with access to warm ocean water. However, it is still possible to have water desalination plants that utilize the water desalination process 100 shown in FIGS. 1-5 near other sources of water that are also colder in temperature.

In a non-limiting embodiment, it is noted that zeolites may be used to absorb any residuals with the ammonium bicarbonate forward osmosis process. In addition, electrodialysis or reverse osmosis could be employed for final polishing at very low cost due very low levels of residuals remaining.

There are various ways to deploy the water desalination system 100 shown in FIGS. 1-5 and described in one or more non-limiting embodiments herein. First, the water desalination system 100 may be deployed as a first stage system to desalinate any body of water containing salt water 102 and/or contaminated water 103. Additionally, it may be deployed as a 1 st and 2nd stage system for greater water recovery or deployed to further desalinate RO brine wastewater in existing RO plants. Additionally, the system 100 may be deployed for high TDS (total dissolved solids) situations such as fracking and mining. The system 100 may also be used for processing wastewater from mines, fracking water, and other types of industrial wastewater. Further, the system 100 may be used to add on to existing reverse osmosis desalination plants, standalone, or simultaneous with reverse osmosis for high salinity requirements plants.

Many other benefits and advantages are offered by the water desalination system 100 as shown in the Figures and described herein in one or more non-limiting embodiments.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted. The term “coupled to” as used herein may refer to a direct or indirect connection. The term “set” may refer to one or more of an item.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A water desalination method that uses forward osmosis, comprising:
(a) creating a partial vacuum in the water desalination system;
(b) after creating the partial vacuum in the water desalination system, raising the temperature of incoming salt water prior to directing the incoming salt water to a forward osmosis (FO) membrane housing;
(c) after step (b) directing the heated incoming salt water to an inlet of a feed side of the (FO) membrane housing;
(d) directing a first amount of concentrated ammonium bicarbonate solution into a draw side of the FO membrane housing, wherein the feed side and the draw side of the FO membrane housing are separated by a FO permeable membrane,
wherein the concentrated ammonium bicarbonate solution functions as a draw solution in the FO membrane housing,
(d) as a result of osmotic pressure, allowing a minimum period of time for the concentrated ammonium bicarbonate to pull a percentage of desalinated product water from the feed side through the FO permeable membrane to the draw side of the FO membrane housing;
(e) flowing brine or other extracted contaminant solutes pulled through the FO membrane housing in the feed side of the FO membrane housing to a collection point for the brine or the other extracted contaminant solutes;
(f) flowing a resulting solution from the draw side of the FO membrane housing, wherein the resulting solution is a combination of the percentage of desalinated product water and ammonium bicarbonate solution and wherein the resulting solution is a diluted ammonium bicarbonate solution;
(g) pumping the resulting solution to a vacuum tank;
(h) directing the pumped resulting solution to a heat source to raise the temperature of the resulting solution;
(i) after step (h), flowing the resulting solution comprising the diluted ammonium bicarbonate from the heat source into a feed side of a hydrophobic membrane housing, wherein the hydrophobic membrane housing comprises a hydrophobic membrane that permits gases to flow through the hydrophobic membrane from the feed side of the hydrophobic membrane housing to a draw side of the hydrophobic membrane housing, wherein the gases are ammonia, carbon dioxide, and water vapor;
(j) allowing the heated resulting solution to be filtered through a hydrophobic membrane of the hydrophobic membrane housing, wherein any ammonium bicarbonate ions in the heated resulting solution are converted or dissociate into the gases in the feed side of the hydrophobic membrane housing, wherein the gases pass through the through the hydrophobic membrane from the feed side of the hydrophobic membrane housing to the draw side of the hydrophobic membrane housing, leaving behind freshwater product water to flow out of the feed side of the hydrophobic membrane housing with traceable amounts of ammonium bicarbonate ions present in the freshwater product water;
(k) flowing the freshwater product water from the feed side of the hydrophobic membrane housing into a feed side of a reverse osmosis (RO) membrane housing;
(l) along with step (k), directing additional clean water into a draw side of the RO membrane housing;
(m) allowing an amount of water in the freshwater product water to be drawn through a membrane of the RO membrane housing, while the traceable amounts of the ammonium bicarbonate ions remain on the feed side of the RO membrane housing;
(n) flowing the resulting freshwater product water having no amount of ammonium bicarbonate ions out of the draw side of the RO membrane housing towards a vacuum tank to be pumped in and out of the vacuum tank;
(o) flowing the pumped resulting freshwater product water into a first heat exchanger to raise the temperature of the pumped resulting freshwater product water;
(p) flowing the pumped resulting freshwater product water from the first heat exchanger for further treatment and end use.

2. The water desalination method of claim 1, wherein raising the temperature of the incoming salt water prior to directing the incoming salt water to a forward osmosis (FO) membrane housing at step (b) further comprises:
directing the incoming salt water into a first side of a second heat exchanger; and
allowing a temperature of the incoming salt water to be raised after exiting the source side of the second heat exchanger pump.

3. The water desalination method of claim 2, further comprising, after step (b) and before step (c), directing the heated incoming saltwater to a source side of a heat pump.

4. The water desalination method of claim 3, further comprising, directing the heated incoming saltwater from the heat pump to a third heat exchanger prior to directing the heated incoming saltwater to the FO membrane at step (c).

5. The water desalination method of claim 1, wherein the heat source comprises heat generated from a power plant, processing plant, or solar plant.

6. The water desalination method of claim 1, wherein the heat source comprises heat emitted from a geothermal well.

7. The water desalination method of claim 2, further comprising, after step (m), directing the traceable amounts of the ammonium bicarbonate ions remain on the feed side of the RO membrane housing through a dividing valve and re-directing the traceable amounts of the ammonium bicarbonate ions to the second heat exchanger further comprising adding liquid to create diluted ammonium bicarbonate.

8. The water desalination method of claim 7, further comprising, directing the diluted ammonium bicarbonate to the second heat exchanger and then to the heat pump to cool a temperature of the diluted ammonium bicarbonate to form a cooler diluted ammonium bicarbonate, and then redirecting the cooler diluted ammonium bicarbonate to the hydrophobic membrane to condense gases into ions.

9. The water desalination method of claim 7, further comprising, the traceable amounts of ammonium bicarbonate ions joining with the ammonium bicarbonate ions emitted from the draw side of the hydrophobic membrane to form the concentrated ammonium bicarbonate solution and directing the concentrated ammonium bicarbonate solution to the draw side of the FO membrane.
